(19) United States
(12) Patent Application Publication
(10) Pub. No.: US 2026/0099307 A1
(43) Pub. Date: Apr. 9, 2026

(54) Automatic Code Topology Determination and Migration

(71) Applicant: Google LLC, Mountain View, CA (US)

(72) Inventors: Yue Hu, Los Altos, CA (US); Kamakshi Kodur, Cupertino, CA (US); Leila Adnan Al-Muhtasib, Atherton, CA (US); Toby Lukas Jungen, Seattle, WA (US); Jose Jorge Jr Jimenez-Olivas, San Jose, CA (US); Shu-Wei Cheng, Mountain View, CA (US)

(21) Appl. No.: 18/909,744

(22) Filed: Oct. 8, 2024

(51) Int. Cl. G06F 8/41

(52) U.S. Cl. CPC G06F 8/433

(57) ABSTRACT

Methods, systems, devices, and non-transitory computer readable media for generating structural communities for code migration are provided. The disclosed technology can include receiving code data comprising code segments and generating a build dependency graph comprising nodes and edges. The nodes can correspond to the code segments and the edges can correspond to dependencies between the code segments. Over a plurality of iterations in which different combinations of the nodes are assigned to communities, based on maximizing a modularity score associated with a modularity of the communities, a structural community assignment comprising an assignment of the nodes to the communities that maximizes the modularity score can be determined. Code migration data based on the structural community assignment can be generated and can include migration tasks associated with migrating the code segments based on the structural community assignment. Furthermore, code migration data can be sent to a code review queue.

### FIELD

The present disclosure relates generally to determining the topology of code segments and automatically migrating the code segments. More particularly, the present disclosure relates to generating build dependency graphs based on code segments and determining structural community assignments based on processing the build dependency graphs.

### BACKGROUND

The development of complex software can involve handling thousands of files that interact in a variety of ways. Additionally, codebases can evolve over time as the code is patched, updated, or has new features added. Changes in one part of the code can result in changes in the relationships between other parts of the code. Further, the management of these changes can require an understanding of relationships between specific parts of the code as well as the overall structure of the code. The determination of these relationships can be done manually based on inspection of the code. However, the process of manually inspecting code can be laborious, especially for monolithic codebases. Further, in the case of large or complex codebases manual inspection of the codebase can be very time consuming and potentially result in errors. Accordingly, there may be different approaches to managing code.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of generating structural community assignments for code migration. The computer-implemented method can comprise receiving, by a computing system comprising one or more processors, code data comprising a plurality of code segments. The computer-implemented method can comprise generating, by the computing system, based on the code data, a build dependency graph comprising a plurality of nodes and a plurality of edges. The plurality of nodes can correspond to the plurality of code segments. Further, the plurality of edges can correspond to a plurality of dependencies between the plurality of code segments. The computer-implemented method can comprise determining, by the computing system, over a plurality of iterations in which different combinations of the plurality of nodes are assigned to a plurality of communities, based on maximizing a modularity score associated with a modularity of the plurality of communities, a structural community assignment comprising an assignment of the plurality of nodes to the plurality of communities that maximizes the modularity score. The modularity score can be based on a density of the plurality of edges within each of the plurality of communities relative to the density of the plurality of edges outside each of the plurality of communities. The computer-implemented method can comprise generating, by the computing system, code migration data based on the structural community assignment. The code migration data can comprise a plurality of migration tasks associated with migrating the plurality of code segments based on the structural community assignment. Furthermore, the computer-implemented method can comprise sending, by the computing system, code migration data to a code review queue.

Another example aspect of the present disclosure is directed to one or more tangible non-transitory computer-readable media storing computer-readable instructions that when executed by one or more processors cause the one or more processors to perform operations. The operations can comprise receiving code data comprising a plurality of code segments. The operations can comprise generating, based on the code data, a build dependency graph comprising a plurality of nodes and a plurality of edges. The plurality of nodes can correspond to the plurality of code segments. Further, the plurality of edges can correspond to a plurality of dependencies between the plurality of code segments. The operations can comprise determining, over a plurality of iterations in which different combinations of the plurality of nodes are assigned to a plurality of communities, based on maximizing a modularity score associated with a modularity of the plurality of communities, a structural community assignment comprising an assignment of the plurality of nodes to the plurality of communities that maximizes the modularity score. The modularity score can be based on a density of the plurality of edges within each of the plurality of communities relative to the density of the plurality of edges outside each of the plurality of communities. The operations can comprise generating code migration data based on the structural community assignment. The code migration data can comprise a plurality of migration tasks associated with migrating the plurality of code segments based on the structural community assignment. Furthermore, the operations can comprise sending code migration data to a code review queue.

Another example aspect of the present disclosure is directed to a computing system comprising: one or more processors; one or more non-transitory computer-readable media storing instructions that when executed by the one or more processors cause the one or more processors to perform operations. The operations can comprise receiving code data comprising a plurality of code segments. The operations can comprise generating, based on the code data, a build dependency graph comprising a plurality of nodes and a plurality of edges. The plurality of nodes can correspond to the plurality of code segments. Further, the plurality of edges can correspond to a plurality of dependencies between the plurality of code segments. The operations can comprise determining, over a plurality of iterations in which different combinations of the plurality of nodes are assigned to a plurality of communities, based on maximizing a modularity score associated with a modularity of the plurality of communities, a structural community assignment comprising an assignment of the plurality of nodes to the plurality of communities that maximizes the modularity score. The modularity score can be based on a density of the plurality of edges within each of the plurality of communities relative to the density of the plurality of edges outside each of the plurality of communities. The operations can comprise generating code migration data based on the structural community assignment. The code migration data can comprise a plurality of migration tasks associated with migrating the plurality of code segments based on the structural community assignment. Furthermore, the operations can comprise sending code migration data to a code review queue.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that can determine structural communities for code migration according to example embodiments of the present disclosure;

FIG. 1B depicts a block diagram of an example computing device that can determine structural communities for code migration according to example embodiments of the present disclosure;

FIG. 1C depicts a block diagram of an example computing device that can determine structural communities for code migration according to example embodiments of the present disclosure;

FIG. 2 depicts a block diagram of examples of machine-learned models according to example embodiments of the present disclosure;

FIG. 3 depicts an example of a computing device according to example embodiments of the present disclosure;

FIG. 4 depicts an example of a structural community assignment according to example embodiments of the present disclosure;

FIG. 5 depicts an example of a computing system configured to perform open loop code migration according to example embodiments of the present disclosure;

FIG. 6 depicts an example of a computing system configured to perform closed loop code migration according to example embodiments of the present disclosure;

FIG. 7 depicts a flow chart diagram of an example method of generating structural community assignments for code migration according to example embodiments of the present disclosure;

FIG. 8 depicts a flow chart diagram of an example method of generating structural community assignments for code migration according to example embodiments of the present disclosure;

FIG. 9 depicts a flow chart diagram of an example method of generating structural community assignments for code migration according to example embodiments of the present disclosure; and

FIG. 10 depicts a flow chart diagram of an example method of training machine-learned models to generate structural community assignments for code migration according to example embodiments of the present disclosure.

Reference numerals that are repeated across plural figures are intended to identify the same features in various implementations.

### DETAILED DESCRIPTION

In general, the present disclosure is directed to generating structural community assignments for use in code migration. In particular, code migration data can be automatically generated based on a structural community assignment that is determined based on a topological analysis process in which a build dependency graph is generated based on code segments (e.g., source code segments of a software application) that are then assigned to communities based on dependencies between the code segments. Further, the structural community assignment can be based on a density of dependencies between code segments and can be used to facilitate the migration of code segments from a monolithic architecture to a more modular architecture. Based on the structural community assignment, the disclosed technology can generate code migration data that comprises migration tasks (e.g., migration instructions) that can be used to direct the migration of code segments. Additionally, the disclosed technology can implement machine-learned models (e.g., auto-encoder machine-learned models) that have been configured and/or trained to determine a structural community assignment in which nodes corresponding to code segments are assigned to communities comprising different combinations of the nodes.

The disclosed technology can include a computing system that receives code data comprising code segments. For example, a plurality of code segments comprising code files that include the source code of a software application can be received by a computing system. After receiving the code data, the computing system can generate a build dependency graph that comprises nodes and edges. The nodes of the build dependency graph can correspond to the code segments and the edges of the build dependency graph can correspond to dependencies between the code segments. For example, the computing system can process the code segments and determine the relationships between the various code segments including functions and/or procedures that are called in various code segments. Further, the computing system can determine libraries that are referenced by the code segments. Over a plurality of iterations, the computing system can determine a structural community assignment that includes an assignment of nodes to communities that comprise different groupings of the nodes. In each iteration, different combinations of the nodes can be assigned to the communities and a modularity score (e.g., a numerical value) based on a density of the edges within each of the communities relative to the density of the edges outside each of communities can be determined. The structural community assignment can include an assignment of the plurality of nodes to the plurality of communities that maximizes the modularity score. For example, the computing system can perform operations to determine different assignments of nodes to communities that correspond to a more efficient arrangement of the plurality of code segments that can allow the code segments to be migrated to a more modular codebase.

The computing system can generate code migration data based on the structural community assignment. The code migration data can comprise migration tasks associated with migrating the code segments based on the structural community assignment. For example, the code migration tasks can comprise a source (e.g., a file location) of the code segments within a monolithic code structure and a destination for the code segments in a more modular code structure. Furthermore, the computing system can send the code migration data to a code review queue. The code migration data can then be reviewed prior to being submitted for integration in a more modular code structure.

Accordingly, the disclosed technology can automatically generate structural community assignments that can be used to migrate code more effectively. In particular, the disclosed technology can be used to optimize monolithic code structures which can in turn improve the speed with which code is migrated as well as reducing errors that can result from manual migration. Further, the disclosed technology can assist a user in more effectively and/or safely performing the technical task of code migration by means of a continued and/or guided human-machine interaction process in which monolithic code can be received and the disclosed technology generates code migration tasks based on continuously updated code data. For example, code data comprising code segments (e.g., portions of the source code of an application) can be processed on a continuous basis, thereby allowing the codebase for an application to be maintained and/or updated more effectively.

The disclosed technology can be implemented in a computing system (e.g., a code migration computing system) that is configured to access data and/or perform operations on the data. For example, the operations performed by the computing system can comprise receiving code data comprising a plurality of code segments, generating a build dependency graph based on the code data, determining a structural community assignment based on the build dependency graph, generating code migration data based on the structural community assignment, and/or sending the code migration data to a review queue. Further, the computing system can leverage one or more machine-learned models that have been configured and/or trained to process (e.g., parse) input comprising code data and/or a build dependency graph and generate a structural community assignment and/or code migration data based on processing the input.

The computing system can be included as part of a system that includes a server computing device that receives data (e.g., code data) from a user's client computing device, performs operations based on the data and sends output comprising code migration data back to the client computing device. In some embodiments, the computing system can include specialized hardware and/or software that enables the performance of operations specific to the disclosed technology. For example, the computing system can include one or more application specific integrated circuits and/or neural processing units that are configured to perform operations associated with receiving code data comprising a plurality of code segments, generating a build dependency graph based on the code data, determining a structural community assignment based on the build dependency graph, generating code migration data based on the structural community assignment, and/or sending the code migration data to a review queue.

The computing system can receive, access, and/or retrieve code data. The code data can comprise a plurality of code segments. For example, the computing system can receive code data comprising a plurality of code segments of a software application. The plurality of code segments can comprise one or more instructions that can be processed by a computing device and cause a computing device to perform operations based on the instructions. For example, the code data can comprise a plurality of code segments that can be used to perform operations comprising generating a user interface (e.g., a graphical user interface), receiving input from a user, sending and/or receiving data from another computing device, processing data, and/or generating output (e.g., output that can include text, images, audio, and/or video) that can be used internally by a computing device or sent to an output device (e.g., a display device).

The plurality of code segments can comprise a plurality of files (e.g., source code files) that can be associated with a plurality of directories. In some embodiments, the plurality of code segments can comprise and/or be associated with one or more documents (e.g., text documents) that can comprise one or more instructions. Further, the plurality of code segments can comprise one or more database files. For example, the plurality of nodes can be associated with and/or correspond to database files or database objects and/or the plurality of edges can be associated with and/or correspond to one or more relationships between the database files and/or database objects.

The plurality of code segments can comprise and/or be associated with any portion of code including one or more variables, one or more functions, one or more methods, one or more procedures, one or more classes, one or more objects, one or more modules, one or more modules, and/or one or more comments. In some embodiments, the plurality of code segments can comprise a plurality of code source files. Further, the plurality of code segments can comprise one or more references to other code segments of the plurality of code segments. The plurality of code segments can use any programming language and/or markup language and can include one or more code segments using C, C++, Java, Python, C#, JavaScript, Perl, PHP, Go, Structured Query Language (SQL), Ruby, R, Swift, Verilog, HTML, XML, CSS, Objective-C, Rust, COBOL, Pascal, Fortran, Lisp, and/or Ada. In some embodiments, the plurality of code segments can comprise a plurality of files (e.g., Unicode files and/or ASCII files). For example, the plurality of code segments can comprise text files that comprise one or more portions of alphanumeric text. Further, the plurality of code segments can comprise identifiers (e.g., file names) that may be used to identify the files. The plurality of code segments can comprise data (e.g., metadata) that indicates the size of a code segment (e.g., a size in kilobytes) and/or the read/write status of the plurality of code segments. In some embodiments, the plurality of code segments can be associated with an interface which can include an application programming interface (API). For example, the plurality of code segments can be associated with an API (e.g., a map application API, a machine-learning model API, or a search application API) that is used to allow communication and/or the exchange of data between software applications.

The computing system can generate and/or determine a build dependency graph. The build dependency graph can be based on the code data. Further, the build dependency graph can comprise a plurality of nodes and/or a plurality of edges. The plurality of nodes can correspond to the plurality of code segments. The plurality of edges can correspond to a plurality of dependencies between the plurality of code segments. Further, the plurality of edges can be associated with and/or correspond to one or more relationships between the plurality of code segments. For example, code data comprising three code segments (e.g., three files) and in which each code segment has dependencies with the other two code segments can be processed by the computing system. The build dependency graph based on the three code segments can have three nodes corresponding to the three code segments and three edges (two edges connecting each of the three nodes to the other two nodes).

Generating and/or determining the build dependency graph can comprise the computing system processing (e.g., parsing) each of the plurality of code segments of the code data. For example, the computing system can access the code data and determine that the plurality of code segments correspond to a plurality of files and/or a plurality of functions and/or methods within the plurality of files. Further, the computing system can determine the plurality of dependencies based on processing and/or parsing one or more variables, one or more functions, one or more methods, one or more procedures, one or more classes, one or more classes, one or more modules, one or more modules, and/or one or more comments. In some embodiments, the computing system can determine the plurality of dependencies based on processing the code data and determining the modules and/or libraries (e.g., standard libraries that are imported into a file) that are called by functions and/or methods within the plurality of code segments. Functions that are called and/or classes that are instantiated can also be used to determine dependency between code segments (e.g., a code segment that uses a class that was instantiated in another code segment). Further, determining the plurality of dependencies can comprise determining variables in code segments that are referenced from other code segments. In some embodiments, the code data comprises configuration information that indicates dependencies between one or more code segments of the plurality of code segments.

The computing system can determine and/or generate a structural community assignment. For example, the structural community assignment can comprise an assignment of nodes (e.g., nodes corresponding to source code files) to communities (e.g., groups of nodes that correspond to groups of source code files). The structural community assignment can be determined and/or generated over a plurality of iterations in which different combinations of the plurality of nodes can be assigned to a plurality of communities. Each iteration can include a different assignment of the plurality of nodes to the plurality of communities. At each iteration (or for each iteration), a modularity score can be generated for the structural community assignment that results from the assignment of nodes to communities. Based on maximizing a modularity score associated with a modularity of the plurality of communities, a structural community assignment comprising an assignment of the plurality of nodes to the plurality of communities that maximizes the modularity score can be determined and/or generated. For example, after a plurality of iterations in which different combinations of a plurality of nodes to a plurality of communities the combination of nodes associated with communities that is associated with the greatest modularity score (e.g., the highest modularity score) can be determined to be structural community assignment.

In some embodiments, a number of the plurality of iterations can be based on a predetermined threshold number of iterations. Determining the predetermined threshold number of iterations can be based on monitoring and/or recording previous determinations of structural community assignments based on different sets of code data and/or build dependency graphs. Further, the computing system can determine a range of a number of iterations after which the modularity score tends to increase minimally or not increase. The predetermined number of iterations can be based on the range of the number of iterations after which the modularity score tends to increase minimally or not increase. For example, if the modularity score tends to have minimal increases or no increases after one hundred (100) iterations, a predetermined threshold number of iterations can be determined to be one hundred (100) iterations. Further, based on the predetermined threshold number of iterations being equal to one hundred (100) iterations, a structural community assignment can be determined to be the assignment of the plurality of nodes to the plurality of communities that is associated with the highest modularity score that was determined and/or generated in the one hundred (100) iterations.

In some embodiments, the plurality of iterations can continue until the modularity score exceeds a modularity score threshold. For example, if the modularity score ranges from one to one hundred, the plurality of iterations can continue until the modularity score exceeds a modularity score threshold of ninety (90).

In some embodiments, an iteration (e.g., a first iteration) of the plurality of iterations can be based on a random assignment of the plurality of nodes to the plurality of communities. For example, in the first iteration, random assignment operations based on a random number algorithm can be performed to generate a random assignment of the plurality of nodes to a plurality of communities.

The modularity score can be based on a density of the plurality of edges within each of the plurality of communities relative to the density of the plurality of edges outside each of the plurality of communities. For example, the computing system can determine a first density of the plurality of edges of the plurality of nodes relative to other nodes within a community and a second density of the plurality of edges relative to other nodes outside of the community. The computing system can then compare the first density to the second density and generate a modularity score based on the difference between the first density and the second density. In some embodiments, the modularity score can be positively correlated with the density of the plurality of edges within the plurality of communities relative to the density of the plurality of edges outside the plurality of communities (e.g., a greater difference in the density of edges inside a community relative to the density of edges outside the community can result in a greater modularity score and a smaller difference can result in a lower modularity score).

In some embodiments, the modularity score can be positively correlated with a difference between an assignment of the plurality of nodes to the plurality of communities and a random assignment of the plurality of nodes to the plurality of communities. For example, the computing system can determine a modularity score for a random assignment of the plurality of nodes to the plurality of communities and compare the modularity score of a non-random assignment of the plurality of nodes to the plurality of communities. Further, the modularity score can be defined as follows:

$$Q = \frac{1}{2 m} {\sum }_{v w} [ {A}_{vw} - \frac{{k}_{v} {k}_{w}}{2 m} ] δ ( {c}_{v} , {c}_{w} )$$

In the preceding equation, the modularity Q can be determined based on the nodes v and w, the community cᵥ associated with the node v, the community c_{w} associated with the node w, A_{vw} is an element of an adjacency matrix of a network (e.g., a network of nodes comprising the nodes v and w), and the node degrees kᵥk_{w}/2 m.

In some embodiments, the modularity score can be negatively correlated with a distance between the plurality of nodes in the plurality of communities. Further, the distance between the plurality of nodes can be based on a number of intervening nodes between a pair of nodes of the plurality of nodes. For example, a structural community assignment in which the plurality of nodes in the plurality of communities have, on average, fewer intervening nodes can have a higher modularity score than a structural community assignment in which there are, on average, a greater number of intervening nodes between nodes in the same community.

In some embodiments, the plurality of code segments can be associated with a plurality of directories. The plurality of code segments associated with a same directory of the plurality of directories can correspond to the plurality of nodes assigned to a same community of the plurality of communities. Further, code segments in a directory can be more likely to have dependencies with other code segments in the same directory. In some embodiments, the computing system can determine that the plurality of code segments in the same directory can correspond to the plurality of nodes in the same community. Further, in the first iteration of the plurality of iterations in which different combinations of the plurality of nodes are assigned to a plurality of communities, the computing system can determine that the plurality of nodes corresponding to the plurality of code segments in the same directory are assigned to the same communities.

In some embodiments, the plurality of nodes assigned to each of the plurality of communities can be mutually exclusive with respect to the plurality of nodes assigned to other communities of the plurality of communities. For example, the computing system can determine that the plurality of nodes assigned to a community may not be assigned to any other community.

In some embodiments, determining a structural community assignment can comprise determining, in a first iteration of the plurality of iterations, that each node of the plurality of nodes is assigned to a different community of the plurality of communities. For example, if there are two thousand (2,000) code segments and two thousand (2,000) corresponding nodes, the computing system can determine that each node of the two thousand (2,000) nodes is assigned to a different community of two thousand (2,000) communities.

Further, determining the structural community assignment can comprise determining, over the plurality of iterations subsequent to the first iteration, mergers of different pairs of the plurality of communities that increase the modularity score by a greatest amount. For example, the computing system can merge different pairs of the plurality of communities and determine the merged pairings of the plurality of communities that cause the modularity score to increase. The computing system can then compare the merged pairings of the plurality of communities that caused the modularity score to increase to determine the merged pairings that increased the modularity score by the greatest amount. The computing system can, over the plurality of iterations, determine the merged pairings of the plurality of communities that maximizes the modularity score.

The computing system can generate code migration data. The code migration data can be based on the structural community assignment. Further, the code migration data can comprise a plurality of migration tasks associated with migrating the plurality of code segments based on the structural community assignment. Generating the code migration data can comprise the computing system determining the plurality of code segments that correspond to the plurality of nodes of the structural community assignment. The plurality of code segments can be clustered into the code migration data based on the communities corresponding to the plurality of code segments. For example, the computing system can access a structural community assignment comprising a first community comprising a first plurality of nodes corresponding to a first plurality of code segments and a second community comprising a second plurality of nodes corresponding to a second plurality of code segments. The computing system can generate a first portion of code migration data based on the first plurality of code segments and a second portion of code migration data based on the second plurality of code segments.

The computing system can determine a source and destination associated with each code segment of the plurality of code segments in the code migration data. For example, the computing system can determine a code segment comprising a location of a code segment that may be migrated to a destination that is the target location for the code segment. In some embodiments, the computing system can add a version identifier to the code migration data. The version identifier can indicate the version associated with a code segment.

The computing system can send the code migration data to a code review queue. For example, the computing system can send the code migration data to a code review queue that is implemented on the computing system or another computing system. In some embodiments, the code migration data can be sent to the code review queue on a periodic basis (e.g., sent hourly or daily). In some embodiments, the code migration data can be sent to the code review queue in response to a request to send the code migration data. The code migration data can be sent to the code review queue based on the priority of the code segments in the code migration data. For example, higher priority code migration data can be sent to the code review queue before lower priority code migration data. In some embodiments, the code migration data can be encrypted before being sent to the code review queue and decrypted when received at the code review queue.

In some embodiments, sending code migration data to a code review queue can comprise determining a number of the plurality of migration tasks in the code review queue. Further, sending the code migration data to the code review queue can comprise determining that the number of the plurality of migration tasks sent to the code review queue does not exceed a task utilization threshold associated with a capacity of the code review queue. For example, the computing system can access the code review queue and/or send a request to the computing system that implements the code review queue to determine the number of the plurality of migration tasks in the code review queue. The computing system can then compare the number of the plurality of migration tasks in the code review queue to the task utilization threshold (e.g., a threshold number of the plurality of migration tasks) send migration tasks to the queue if the number of migration tasks in the code review queue does not exceed the task utilization threshold. If the number of migration tasks in the code review queue meets or exceeds the task utilization threshold, the computing device may not send the code migration data to the code review queue until the migration tasks in the code review queue fall below the task utilization threshold.

In some embodiments, sending code migration data to a code review queue can comprise determining, based on a distance between the plurality of nodes, a migration priority associated with an order in which the plurality of migration tasks are sent to the code review queue. The migration priority of the plurality of migration tasks can be positively correlated with the distance between a pair of the plurality of code segments associated with the plurality of migration tasks. The distance between the plurality of nodes can be based on the number of edges between a pair of the plurality of nodes. Further, the plurality of migration tasks can be sent to the code review queue in an order based on the migration priority. For example, migration tasks that are higher priority can be sent to the code review queue before migration tasks that are lower priority.

In some embodiments, determining the structural community assignment and/or determining the plurality of communities can be performed by one or more machine-learned models. The one or more machine-learned models can comprise one or more auto-encoder models. Further, the one or more machine-learned models can be configured and/or trained to determine a structural community assignment. The computing system can receive training data. The training data can comprise a plurality of training build dependency graphs comprising a plurality of training nodes connected by a plurality of training edges. The plurality of training build dependency graphs can be associated with a corresponding plurality of ground-truth structural community assignments. The plurality of training nodes can be associated with a plurality of training code segments. Further, the plurality of training edges can indicate dependencies between the plurality of training code segments.

In some embodiments, the training data can comprise a plurality of embeddings. The plurality of embeddings can comprise a lower-dimensionality vector space representation of the training data. For example, the plurality of training build dependency graphs can be represented in a lower-dimensional vector space that can preserve information about the dependencies between code segments in a smaller dimensional vector space than the higher-dimensional vector space of the original build graph (e.g., a high-dimensional vector space that can include every training node of the plurality of training nodes). The plurality of embeddings can be arranged such that semantically similar code segments are closer together in the vector space.

Further, training the one or more machine-learned models can comprise generating and/or determining, based on inputting the training data into the one or more machine-learned models, a plurality of predicted structural community assignments. Based on the received input, the one or more machine-learned models can perform one or more operations and generate an output comprising a plurality of predicted structural community assignments associated with the corresponding plurality of training build dependency graphs. The output of the one or more machine-learned models can then be evaluated based on one or more comparisons of the plurality of predicted structural community assignments to a corresponding plurality of ground-truth structural community assignments associated with the training data (e.g., ground-truth structural community assignments based on the same build dependency graph as the corresponding predicted structural community assignments).

Training the one or more machine-learned models can comprise determining a loss based on one or more differences between the plurality of predicted structural community assignments and the plurality of ground-truth structural community assignments. A loss function can be used to determine the loss. Further, the loss function can be used to evaluate one or more differences between the plurality of predicted structural community assignments and the plurality of ground-truth structural community assignments. The loss can increase in proportion to the number of the one or more differences between the plurality of predicted structural community assignments and the plurality of ground-truth structural community assignments. For example, if a predicted structural community assignment and the corresponding ground-truth structural community assignment comprise ten thousand nodes and the plurality of predicted structural community assignments has seventy communities that are different from the plurality of ground-truth structural community assignments, the loss can be greater than if the predicted structural community has twenty communities that are different from the corresponding ground-truth structural community assignment.

Further, the loss can increase in proportion to the magnitude of differences between the plurality of predicted structural community assignments and the plurality of ground-truth structural community assignments. For example, a predicted structural community assignment that is based on the same build dependency graph as a corresponding ground-truth structural community assignment and has a very different modularity score (e.g., has a much lower modularity score or a much higher modularity score) from a ground-truth structural community assignment can result in a greater loss than a predicted structural community assignment that has a slightly different modularity score (e.g., a slightly lower modularity score or a slightly higher modularity score) from a corresponding ground-truth structural community assignment.

Training the one or more machine-learned models can comprise modifying a plurality of parameters of the one or more machine-learned models to minimize the loss. The plurality of parameters can be associated with detection, recognition, and/or classification of one or more features of the training data that can be used to determine the plurality of predicted structural community assignments. Further, the plurality of parameters can be associated with a plurality of weights that can be associated with an extent to which the plurality of parameters contribute to determining the loss.

Training the one or more machine-learned models can be performed over a plurality of iterations. In each iteration of training, the weight of the plurality of parameters that contribute to increasing the loss can be reduced and/or the weight of the plurality of parameters that contribute to decreasing the loss can be increased. As a result, the plurality of weights of the plurality of parameters can be associated with the plurality of predicted structural community assignments such that parameters that are more heavily weighted can contribute more to determining the predicted structural community assignments than parameters that are less heavily weighted. Over the plurality of iterations, the weights of the plurality of parameters can be modified to minimize the loss until a threshold loss that corresponds to a high accuracy of the one or more machine-learned models determining the plurality of predicted structural community assignments is achieved. For example, the loss can be minimized until a threshold loss associated with 99% accuracy is achieved by the machine-learned model.

The systems, methods, devices, and/or computer-readable media (e.g., tangible non-transitory computer-readable media) in the disclosed technology can provide a variety of technical effects and benefits including an improvement in the effectiveness with which a more modular code structure can be generated. In particular, the disclosed technology can be used to migrate code segments to a more modular codebase based on processing a monolithic code codebase. Further, the disclosed technology can improve the code migration process by automating the determination of code communities associated with code segments that are more closely related. The disclosed technology can also improve the effectiveness with which computational resources are used by leveraging one or more machine-learned models that are configured and/or trained to determine structural community assignments.

The disclosed technology can automate the determination of code communities that are associated with code segments that share dependencies, which can result in improved code migration (e.g., faster migration), especially when compared to the manual determination of dependencies between code segments. A modularity algorithm can be used to determine code communities that are more closely related, which can result in a more modular codebase. A modular codebase can make the constituent code segments easier to update and maintain. A more modular codebase that is more efficiently organized can result in an improvement in the use of computing resources such as processing resources, storage resources, and/or memory resources.

Additionally, the disclosed technology can automatically manage the migration of the code so that merge conflicts are minimized. In this way, the potentially time-consuming task of manually attempting to determine which code segments are dependent on other code segments can be automatically performed by the disclosed technology.

As such, the disclosed technology can allow the user of a computing system to perform the technical task of migrating code based on the determination of structural community assignments of code segments. As a result, users can be provided with the specific benefits of improved performance (migration performance), a reduction in migration errors and conflicts, and more efficient use of system resources. Further, any of the specific benefits provided to users can be used to improve the effectiveness of a wide variety of devices and services including services that process and/or migrate code segments. Accordingly, the improvements offered by the disclosed technology can result in tangible benefits to a variety of devices and/or systems including mechanical, electronic, and computing systems associated with generating structural community assignments and/or migrating code segments.

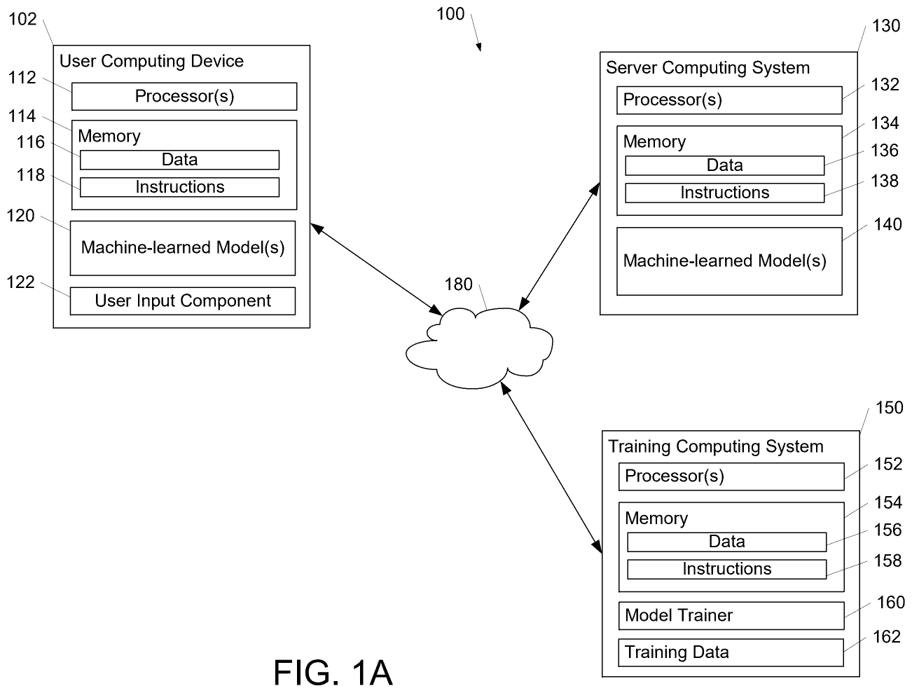

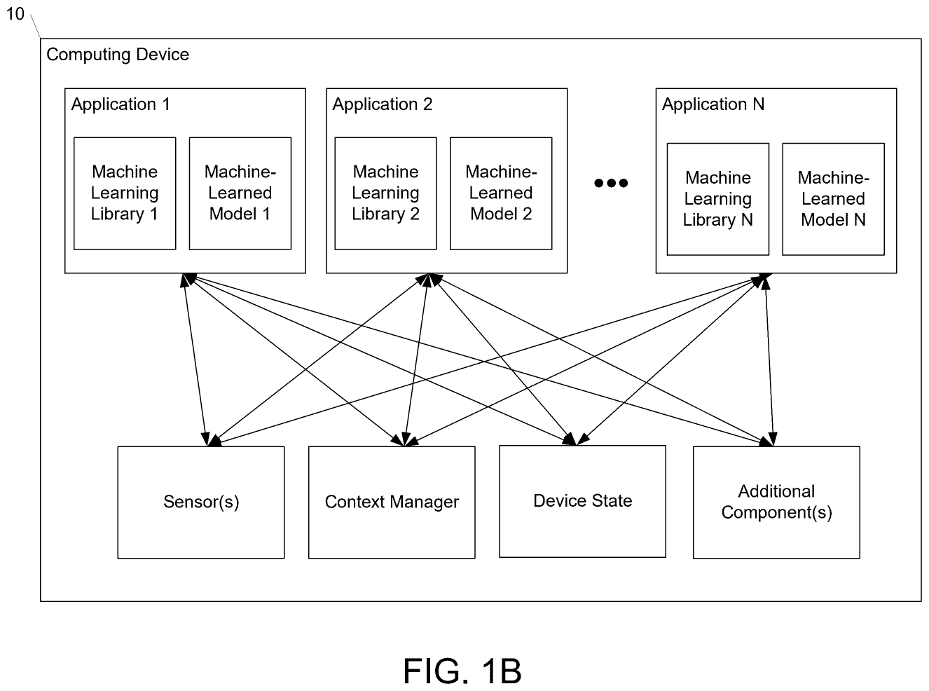

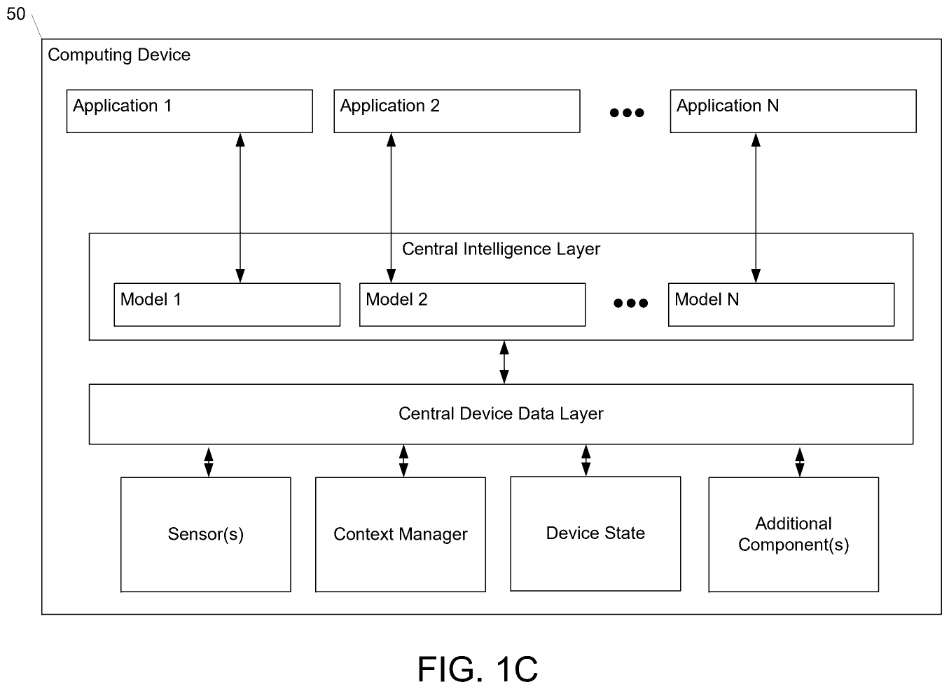

With reference now to the figures, example embodiments of the present disclosure will be discussed in further detail. FIG. 1A depicts a block diagram of an example computing system that can determine structural communities for code migration according to example embodiments of the present disclosure. System 100 includes a computing device 102, a server computing system 130, and a training computing system 150 that are communicatively coupled over a network 180.

The computing device 102 can comprise any type of computing device, including, for example, a personal computing device (e.g., laptop computing device or desktop computing device), a mobile computing device (e.g., smartphone or tablet), a gaming console or controller, an embedded computing device, a wearable computing device (e.g., a smartwatch), or any other type of computing device.

The computing device 102 includes one or more processors 112 and a memory 114. The one or more processors 112 can be any suitable processing device (e.g., a processor core, a microprocessor, an ASIC, an FPGA, a controller, and/or a microcontroller) and can be one processor or a plurality of processors that are operatively connected. The memory 114 can include one or more non-transitory computer-readable storage media, such as RAM, ROM, EEPROM, EPROM, flash memory devices, magnetic disks, and/or combinations thereof. The memory 114 can store data 116 and instructions 118 which are executed by the processor 112 to cause the computing device 102 to perform operations.

In some implementations, the computing device 102 can store or include one or more machine-learned models 120. For example, the one or more machine-learned models 120 can be or can otherwise include various machine-learned models such as neural networks (e.g., deep neural networks) or other types of machine-learned models, comprising non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Further, the one or more machine-learned models 120 can comprise one or more large language models (LLMs), one or more generative adversarial networks (GANs), one or more encoders, one or more decoders, one or more auto-encoders, and/or one or more embedding models. Examples of one or more machine-learned models 120 are discussed with reference to FIGS. 1-10.

In some implementations, the one or more machine-learned models 120 can be received from the server computing system 130 over network 180, stored in the memory 114, and then used or otherwise implemented by the one or more processors 112. In some implementations, the computing device 102 can implement multiple parallel instances of a single machine-learned model of the one or more machine-learned models 120 (e.g., to perform parallel structural community assignment and/or code migration operations across multiple instances of the one or more machine-learned models 120).

More particularly, the one or more machine-learned models 120 can comprise one or more machine-learned models (e.g., one or more auto-encoders) that are configured and/or trained to perform operations comprising receiving code data comprising a plurality of code segments, generating a build dependency graph based on the code data, determining a structural community assignment based on the build dependency graph, generating code migration data based on the structural community assignment, and/or sending the code migration data to a review queue.

Additionally or alternatively, one or more machine-learned models 140 can be included in or otherwise stored and implemented by the server computing system 130 that communicates with the computing device 102 according to a client-server relationship. For example, the one or more machine-learned models 140 can be implemented by the server computing system 130 as a portion of a web service (e.g., a structural community assignment and/or code migration service). Thus, one or more machine-learned models 120 can be stored and implemented at the computing device 102 and/or one or more machine-learned models 140 can be stored and implemented at the server computing system 130.

The computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an NPU, an FPGA, a controller, and/or a microcontroller) and can be one processor or a plurality of processors that are operatively connected. The memory 134 can include one or more non-transitory computer-readable storage media, such as RAM, ROM, EEPROM, EPROM, flash memory devices, magnetic disks, and/or combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the one or more machine-learned models 140 can be or can otherwise include various machine-learned models. Example machine-learned models include auto-encoders, neural networks, and/or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Examples of one or more machine-learned models 140 are discussed with reference to FIGS. 1-10.

The computing device 102 and/or the server computing system 130 can train the one or more machine-learned models 120 and/or the one or more machine-learned models 140 via interaction with the training computing system 150 that can be communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, and/or a microcontroller) and can be one processor or a plurality of processors that are operatively connected. The memory 154 can include one or more non-transitory computer-readable storage media, such as RAM, ROM, EEPROM, EPROM, flash memory devices, magnetic disks, and/or combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the one or more machine-learned models 120 and/or the one or more machine-learned models 140 stored at the computing device 102 and/or the server computing system 130 using various training or learning techniques (e.g., machine-learning techniques), such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a plurality of training iterations.

In some implementations, performing backwards propagation of errors can include performing truncated backpropagation through time. The model trainer 160 can perform a number of generalization techniques (e.g., weight decays, dropouts, and/or other generalization techniques.) to improve the generalization capability of the models being trained. In particular, the model trainer 160 can train the one or more machine-learned models 120 and/or the one or more machine-learned models 140 based on a set of training data 162. The training data 162 can include various types of data. For example, the training data 162 can include code data, build dependency graph data, and/or code migration data. For example, the training data 162 can comprise training code data comprising a plurality of training code segments, training build dependency graphs based on the plurality of training code segments and a corresponding plurality of ground-truth structural community assignments that are associated with at least a threshold modularity score. The model trainer 160 can train and/or retrain the one or more machine-learned models 120 and/or the one or more machine-learned models 140 based on additional data from the training data 162 which can comprise additional code data (e.g., updated code data), new types of code data (e.g., new types of code data based on new code syntax and/or code formats), and/or one or more modifications to existing code data.

In some implementations, if a user has provided consent (e.g., the user provides affirmative consent for another party to use the user's code data), the training examples can be provided by the computing device 102. Thus, in such implementations, the one or more machine-learned models 120 provided to the computing device 102 can be trained by the training computing system 150 on user-specific data received from the computing device 102. In some instances, this process can be referred to as personalizing the model.

The model trainer 160 includes computer logic utilized to provide desired functionality. The model trainer 160 can be implemented in hardware, firmware, and/or software controlling a general-purpose processor. For example, in some implementations, the model trainer 160 includes program files stored on a storage device, loaded into a memory, and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification can be used in a variety of tasks, applications, and/or use cases. In some implementations, the input to the machine-learned model(s) of the present disclosure can be text or natural language data. The machine-learned model(s) can process the text or natural language data to generate an output (e.g., based on inputting queries from a user the machine-learned model(s) can process and generate an analysis comprising one or more explanations and visualizations associated with the queries and image data of the user). As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language). As another example, the machine-learned model(s) can process the text or natural language data to generate a prediction output.

In some implementations, the input to the machine-learned model(s) of the present disclosure can comprise speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data). As another example, the machine-learned model(s) can process the speech data to generate an upscaled speech output (e.g., speech data that is higher quality than the input speech data). As another example, the machine-learned model(s) can process the speech data to generate a textual representation output (e.g., a textual representation of the input speech data). As another example, the machine-learned model(s) can process the speech data to generate a prediction output.

In some implementations, the input to the machine-learned model(s) of the present disclosure can comprise latent encoding data (e.g., a latent space representation of an input). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can comprise statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can comprise sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task can be an audio compression task. The input can include audio data and the output can comprise compressed audio data. In another example, the input includes visual data (e.g., one or more images or videos), the output comprises compressed visual data, and the task is a visual data compression task. In another example, the task can comprise generating an embedding for input data (e.g., input audio data or visual data).

In some cases, the input includes audio data representing a spoken utterance and the task is a speech recognition task. The output can comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the computing device 102 can include the model trainer 160 and the training data 162. In such implementations, the one or more machine-learned models 120 can be both trained and used locally at the computing device 102. In some of such implementations, the computing device 102 can implement the model trainer 160 to personalize the one or more machine-learned models 120 based on user-specific data.

FIG. 1B depicts a block diagram of an example computing device that can determine structural communities for code migration according to example embodiments of the present disclosure. A computing device 10 can be a user computing device or a server computing device.

The computing device 10 can include a number of applications (e.g., applications 1 through N). Each application contains its own machine-learned library and machine-learned model(s). For example, each application can include a machine-learned model. Example applications include a code data processing application, a build dependency graph generation application, a structural community assignment determination application, a code migration data generation application, a social media application, a text messaging application, an email application, a dictation application, a virtual keyboard application, and/or a browser application.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device that can determine structural communities for code migration according to example embodiments of the present disclosure. A computing device 50 can be a user computing device or a server computing device.

The computing device 50 includes a number of applications (e.g., applications 1 through N). Each application is in communication with a central intelligence layer. Example applications include a code processing application (e.g., an application that is used to receive and/or process code data), a build dependency generation application (e.g., an application that is used to generate build dependency graphs based on code data), a structural community assignment determination application (e.g., an application that is used to determine structural communities), a code migration data generation application (e.g., an application that is used to generate code migration data), a text messaging application, an email application, a dictation application, a virtual keyboard application, and/or a browser application. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

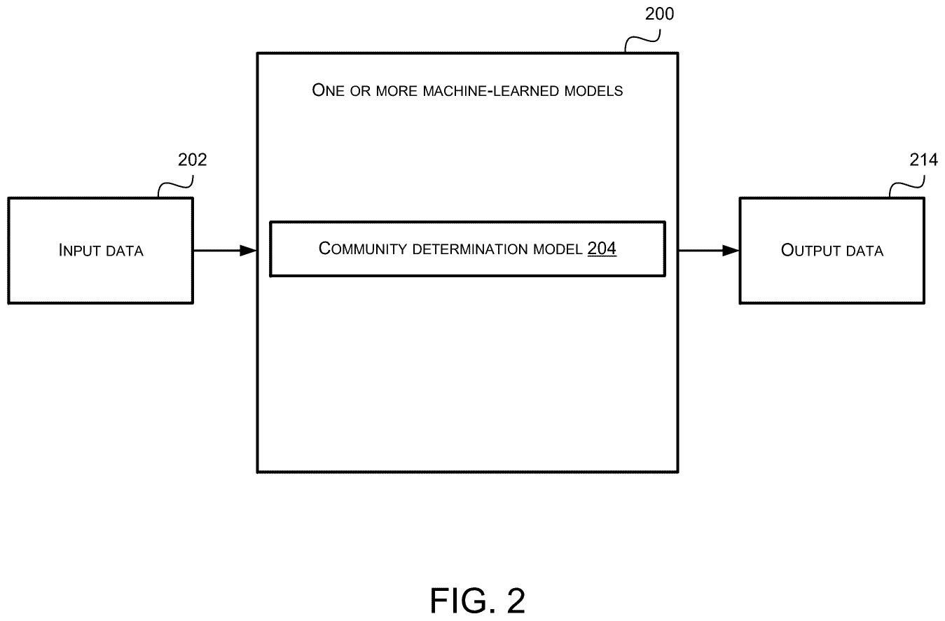

FIG. 2 depicts a block diagram of examples of machine-learned models according to example embodiments of the present disclosure. In some implementations, the one or more machine-learned models 200 can be trained to receive input data 202 that can comprise code data comprising a plurality of code segments and/or build dependency graph data comprising one or more build dependency graphs. As a result of receipt of the input data 202 the one or more machine-learned models 200 can generate output data 214 that can comprise one or more structural community assignments and/or code migration data comprising a plurality of migration tasks.

In some implementations, the one or more machine-learned models 200 can include a structural community assignment determination model 204 that is operable to determine communities of code segments based on the input data 202 (e.g., input data comprising code data and/or build dependency graph data).

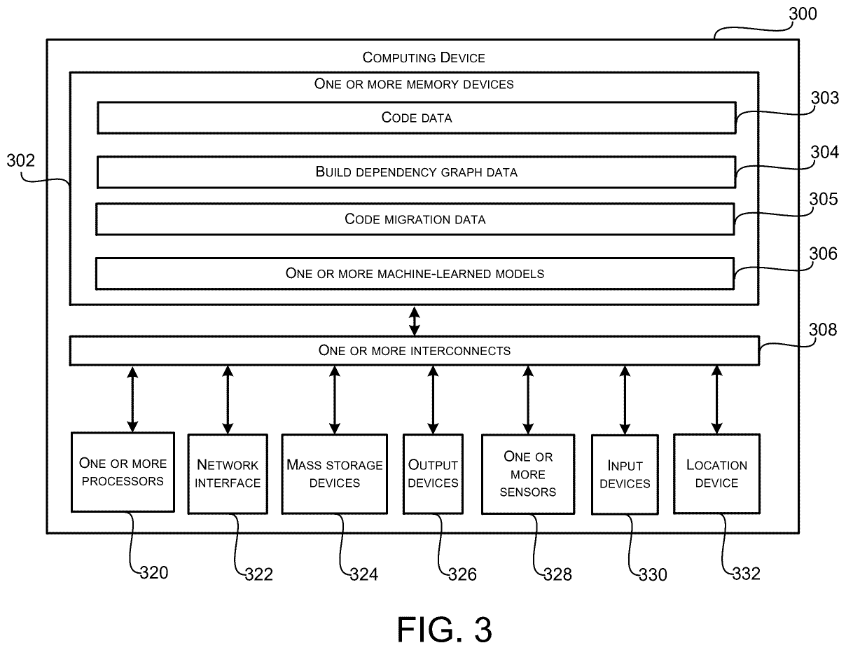

FIG. 3 depicts an example of a computing device according to example embodiments of the present disclosure. A computing device 300 can include one or more features and/or capabilities of the computing device 102, the server computing system 130, and/or the training computing system 150. Furthermore, the computing device 300 can perform one or more actions and/or operations performed by the computing device 102, the server computing system 130, and/or the training computing system 150, which are described with respect to FIG. 1A.

As shown in FIG. 3, the computing device 300 can include one or more memory devices 302, code data 303, build dependency graph data 304, code migration data 305, one or more machine-learned models 306, one or more interconnects 308, one or more processors 320, a network interface 322, one or more mass storage devices 324, one or more output devices 326, one or more sensors 328, one or more input devices 330, and/or the location device 332. The computing device 300 can be configured as a desktop computing device and/or a mobile computing device (e.g., a smartphone, tablet computing device, and/or laptop computing device). Further, the computing device 300 can process and/or generate data (e.g., code migration data) based on data (e.g., code data) of the computing device 300 and/or data that is received from another computing device (e.g., code data that is generated by a remote computing device). The one or more memory devices 302 can store information and/or data (e.g., the code data 303, the build dependency graph data 304, the code migration data 305, and/or the one or more machine-learned models 306). Further, the one or more memory devices 302 can include one or more computer-readable mediums (e.g., tangible non-transitory computer-readable media), including RAM, ROM, EEPROM, EPROM, flash memory devices, magnetic disks, and combinations thereof. The information and/or data stored by the one or more memory devices 302 can be executed by the one or more processors 320 to cause the computing device 300 to perform operations including receiving code data comprising a plurality of code segments, generating a build dependency graph based on the code data, determining a structural community assignment based on the build dependency graph, generating code migration data based on the structural community assignment, and/or sending the code migration data to a review queue.

The code data 303 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. The code data 303 can comprise one or more code segments. The plurality of code segments can comprise one or more dependencies that indicate a dependency between one code segment and one or more other code segments. For example, the code data 303 can comprise a plurality of code segments of an application (e.g., a software application). In some embodiments, the code data 303 can be received from one or more computing systems (e.g., the server computing system 130 that is depicted in FIG. 1A) which can include one or more computing systems that are remote from the computing device 300. Further, the plurality of segments of the code data 303 can comprise one or more instructions that can be used by the computing device 300 and/or another computing device to perform operations. For example, the code data 303 can be associated with a map application and can comprise instructions to determine geographic locations and retrieve map data for the geographic locations.

The build dependency graph data 304 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. In some embodiments, the build dependency graph data 304 can be received from one or more computing systems (e.g., the server computing system 130 that is depicted in FIG. 1A) which can include one or more computing systems that are remote from the computing device 300. The build dependency graph data 304 can comprise a plurality of nodes that correspond to the one or more code segments of the code data 303. Further, the build dependency graph data 304 can comprise a plurality of edges that correspond to a plurality of dependencies between the plurality of code segments of the code data 303.

The code migration data 305 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the code migration data 305 can include information associated with migration of the code data. The code migration data 305 can comprise a structural community assignment that indicates the assignment of the plurality of nodes to a plurality of communities. Further, the code migration data 305 can comprise a plurality of migration tasks associated with migrating the plurality of code segments based on the structural community assignment. In some embodiments, the code migration data 305 can be received from one or more computing systems (e.g., the server computing system 130 that is depicted in FIG. 1A) which can include one or more computing systems that are remote from the computing device 300.

The one or more machine-learned models 306 (e.g., the one or more machine-learned models 120, the one or more machine-learned models 140, and/or the machine-learned models 200) can include one or more portions of the data 116, the data 136, and/or the data 156 which are depicted in FIG. 1A and/or instructions (e.g., the instructions 118, the instructions 138, and/or the instructions 158 which are depicted in FIG. 1A) that are stored in the memory 114, the memory 134, and/or the memory 154, respectively. Furthermore, the one or more machine-learned models 306 can be configured and/or trained to perform operations comprising receiving code data comprising a plurality of code segments, generating a build dependency graph based on the code data, determining a structural community assignment based on the build dependency graph, generating code migration data based on the structural community assignment, and/or sending the code migration data to a review queue. In some embodiments, the one or more machine-learned models 306 can be received from one or more computing systems (e.g., the server computing system 130 that is depicted in FIG. 1A) which can include one or more computing systems that are remote from the computing device 300.

The one or more interconnects 308 can include one or more interconnects or buses that can be used to send and/or receive one or more signals (e.g., electronic signals) and/or data (e.g., the code data 303, the build dependency graph data 304, the code migration data 305, and/or the one or more machine-learned models 306) between devices of the computing device 300, including the one or more memory devices 302, the one or more processors 320, the network interface 322, the one or more mass storage devices 324, the one or more output devices 326, the one or more sensors 328, and/or the one or more input devices 330. The one or more interconnects 308 can be arranged or configured in different ways, including as parallel or serial connections. Further the one or more interconnects 308 can include one or more internal buses to connect the internal components of the computing device 300; and one or more external buses used to connect the internal components of the computing device 300 to one or more external devices. By way of example, the one or more interconnects 308 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (Fire Wire), and/or other interfaces that can be used to connect components.

The one or more processors 320 can include one or more computer processors that are configured to execute the one or more instructions stored in the one or more memory devices 302. For example, the one or more processors 320 can, for example, include one or more general purpose central processing units (CPUs), application specific integrated circuits (ASICs), neural processing units (NPUs), and/or one or more graphics processing units (GPUs). Further, the one or more processors 320 can perform one or more actions and/or operations including one or more actions and/or operations associated with the code data 303, the build dependency graph data 304, the code migration data 305, and/or the one or more machine-learned models 306. The one or more processors 320 can include single or multiple core devices including a microprocessor, microcontroller, integrated circuit, and/or a logic device.

The network interface 322 can support network communications. For example, the network interface 322 can support communication via networks including a local area network and/or a wide area network (e.g., the Internet). Further, the network interface 322 can be used to receive data (e.g., code data) from other computing devices. The one or more mass storage devices 324 (e.g., a hard disk drive and/or a solid-state drive) can be used to store data including the build dependency graph data 304 and/or the one or more machine-learned models 306.

The one or more output devices 326 can include one or more display devices (e.g., LCD display, OLED display, Mini-LED display, microLED display, plasma display, and/or CRT display), one or more light sources (e.g., LEDs), one or more audio output devices (e.g., one or more loudspeakers), and/or one or more haptic output devices (e.g., one or more devices that are configured to generate vibratory output). For example, the one or more output devices 326 can comprise a touch sensitive display that is used to output an interface (e.g., a user interface) that can be configured to display indications based on the code data 303, the build dependency graph data 304, and/or the code migration data 305.

The one or more sensors 328 can comprise one or more LiDAR devices, one or more sonar devices, one or more radar devices, one or more accelerometers, one or more gyroscopes, one or more altimeters, and/or one or more temperature sensors (e.g., one or more thermometers). The one or more input devices 330 can include one or more keyboards, one or more touch sensitive devices (e.g., a touch screen display), one or more buttons (e.g., a power button and/or volume buttons), one or more microphones, and/or one or more imaging devices (e.g., one or more cameras).

The one or more memory devices 302 and the one or more mass storage devices 324 are illustrated separately, however, the one or more memory devices 302 and the one or more mass storage devices 324 can be regions within the same memory module. The computing device 300 can include one or more additional processors, memory devices, network interfaces, which can be provided separately or on the same chip or board. The one or more memory devices 302 and the one or more mass storage devices 324 can include one or more computer-readable media, including, but not limited to, non-transitory computer-readable media, RAM, ROM, hard drives, flash drives, and/or other memory devices.

The one or more memory devices 302 can store sets of instructions for applications including an operating system that can be associated with various software applications or data. For example, the one or more memory devices 302 can store sets of instructions for applications that can generate output including the code migration data 305. The one or more memory devices 302 can be used to operate various applications including a mobile operating system developed specifically for mobile devices. As such, the one or more memory devices 302 can store instructions that allow the software applications to access data including data associated with the determination of structural community assignments and/or the generation of code migration data. In other embodiments, the one or more memory devices 302 can be used to operate or execute a general-purpose operating system that operates on both mobile and stationary devices, including for example, smartphones, laptop computing devices, tablet computing devices, and/or desktop computers.

The software applications that can be operated or executed by the computing device 300 can include applications associated with the system 100 shown in FIG. 1A. Further, the software applications that can be operated and/or executed by the computing device 300 can include native applications and/or web-based applications.

The location device 332 can include one or more devices or circuitry for determining the position of the computing device 300. For example, the location device 332 can determine an actual and/or relative position of the computing device 300 by using a satellite navigation positioning system (e.g., a GPS system, a Galileo positioning system, the GLObal Navigation satellite system (GLONASS), and/or the BeiDou Satellite Navigation and Positioning system), an inertial navigation system, a dead reckoning system, based on IP address, by using triangulation and/or proximity to cellular towers and/or Wi-Fi hotspots.

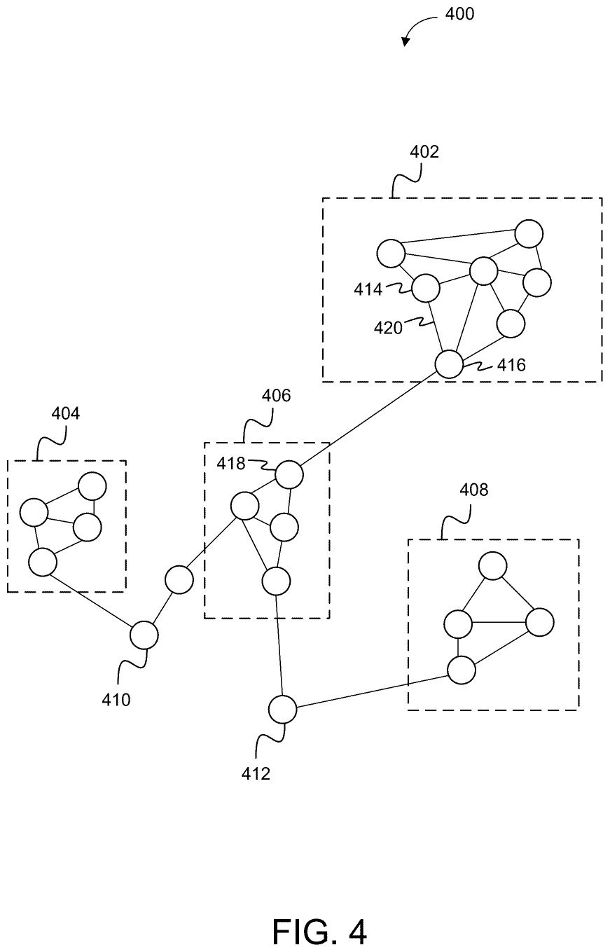

FIG. 4 depicts an example of a structural community assignment according to example embodiments of the present disclosure. The structural community assignment 400 can be generated using computing systems that include one or more features and/or capabilities of the computing device 102, the server computing system 130, the training computing system 150, and/or the computing device 300.

The structural community assignment 400 comprises community 402, community 404, community 406, community 408, a plurality of nodes comprising nodes 410-418, and a plurality of edges comprising the edge 420.

The structural community assignment 400 can comprise a build dependency graph in which a plurality of nodes (e.g., the nodes 414 and 416) correspond to a plurality of code segments. Further, the build dependency graph of the structural community assignment comprises a plurality of edges (e.g., the edge 420) that correspond to dependencies between the code segments that are represented as nodes in the build dependency graph. In this example, the communities 402-408 correspond to clusters of nodes that were determined based on an iterative process in which the plurality of nodes were assigned to different combinations of communities based on maximization of a modularity score associated with the density of edges of nodes to other nodes in a community relative to the density of edges of nodes to other nodes outside the community. The nodes in the community 402 have a higher density of edges relative to other nodes in the community 402 than the density of edges with respect to nodes outside the community 402. For example, the node 416 is connected (by three edges) to three different nodes within the community 402 but only connected (by one edge) to one node (e.g., the node 418) that is outside the community 402. Similarly, the communities 404-408 have a higher density of edges with respect to other nodes within the respective communities than with respect to nodes outside the communities.

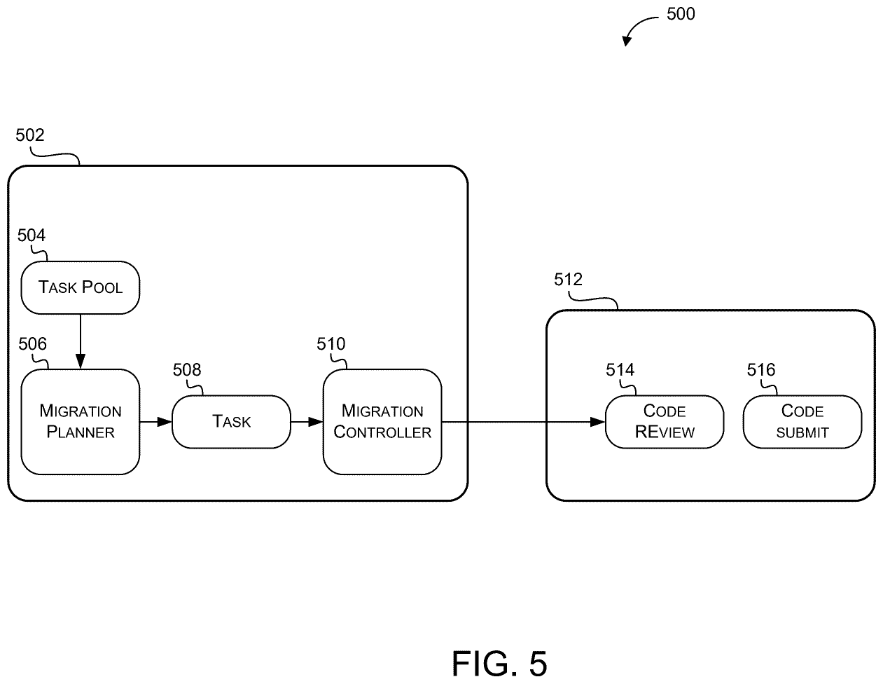

FIG. 5 depicts an example of a computing system configured to perform open loop code migration according to example embodiments of the present disclosure. A computing system 500 can include one or more features and/or capabilities of the computing device 102, the server computing system 130, the training computing system 150, the computing device 300, and/or the computing system 600. Furthermore, the computing system 500 can perform one or more actions and/or operations that can be performed by the computing device 102, the server computing system 130, the training computing system 150, the computing device 300, and/or the computing system 600.

The computing system 500 can comprise the migration computing device 502, the task pool 504, the migration planner 506, the task 508, the migration controller 510, the review computing device 512, the code review queue 514, and the code submit queue 516.

The migration computing device 502 can be configured to generate code migration data that can be sent to the review computing device 512. The task pool 504 can comprise code migration data which can comprise a plurality of migration tasks. The plurality of migration tasks from the task pool 504 can be sent to the migration planner 506. The migration planner 506 can be configured to determine a priority of each of the plurality of tasks from the task pool 504. The priority of the tasks from the task pool 504 can be used to determine an order in which each of the plurality of tasks from the task pool is sent to the migration controller 510. In this example, the task 508 (e.g., a migration task) can comprise information associated with a source and/or a destination of the task 508. In some embodiments, the task 508 can comprise an atomic migration instruction that can be used to migrate a code segment. The source of the task 508 can comprise a task from a codebase (e.g., a monolithic codebase) that is being migrated and/or a task from a community the task 508 is associated with. For example, the task 508 can comprise a code segment (e.g., a code file) that is part of a community associated with a structured community assignment. The destination of the task 508 can comprise a target codebase to which the code segment in the task 508 can be migrated.

The task 508 can be sent to the migration controller 510 which can be configured to send tasks to the code review queue 514 of the review computing device 512. In some embodiments, the migration controller 510 can be configured to send parallel migration tasks (e.g., migration tasks that do not cause merge conflicts during migration and can be associated with other migration tasks in the same community). The migration controller 510 can send tasks comprising the task 508 to the code review queue 514 that is implemented in the review computing device 512. The code review queue 514 can comprise a plurality of tasks that can be reviewed and sent to the code submit queue 516 for submission to a destination codebase.

In some embodiments, the operations performed by the computing system 500 can be based on the Open Loop Task Migration Code indicated in the following excerpt.

```
// Open Loop Task Migration Code
procedure MigrationPlanner(taskPool):
  G := Dependency Graph of an Application
  M := empty DependencyGraph
  ready_queue := empty Queue
  for each (source, destination) ϵ taskPool:
    subgraph := G.subgraph(source)
    if M.is_separate_component(subgraph):
      M.add(subgraph)
      ready_queue.enquque((source, destination))
  return ready_queue
procedure MigrationController(ready_queue):
  while ready_queue not empty:
    task:=ready_queue.dequeue( )
    migrate(task)
```

In the preceding excerpt, code segments comprising instructions for open loop migration comprising a migration planner and a migration controller are provided. The migration planner can be implemented as a procedure “MigrationPlanner (taskPool)” in which a task from a taskPool is a parameter. “G” indicates a dependency graph of an application (e.g., a map application) and “M” indicates an empty dependency graph. Each task from the taskPool can be added to the empty graph in preparation for migration. The migration controller can be implemented as a procedure “MigrationController (ready_queue) in which the ready_queue from the MigrationPlanner procedure is a parameter. The migration controller can migrate tasks to the code review queue as long as the condition that the ready_queue is not empty is met. In the Open Loop Task Migration Code, the MigrationController can terminate migration of migration tasks after a single control cycle.

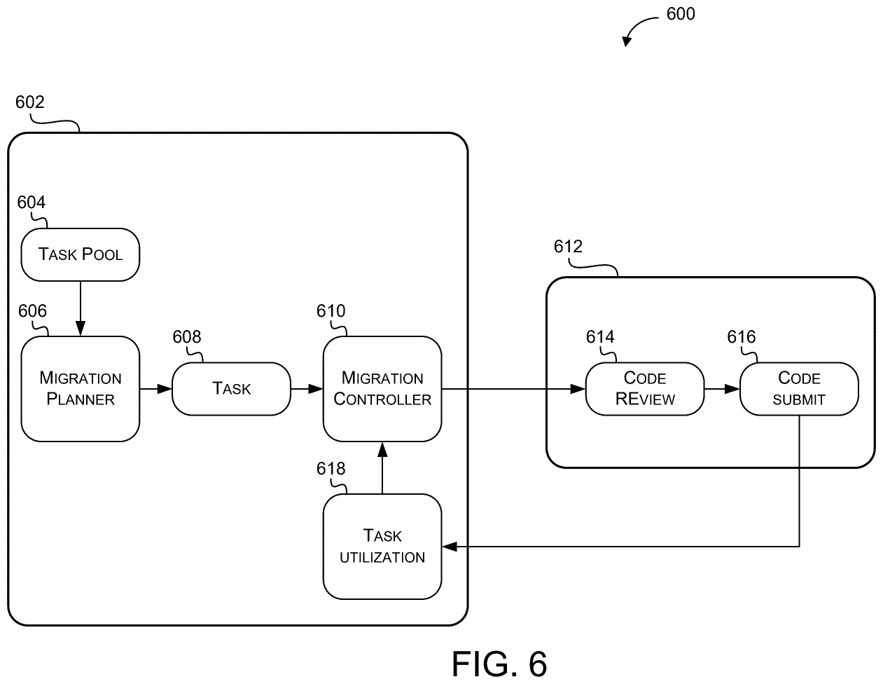

FIG. 6 depicts an example of a computing system configured to perform open loop code migration according to example embodiments of the present disclosure. A computing system 600 can comprise one or more features and/or capabilities of the computing device 102, the server computing system 130, the training computing system 150, the computing device 300, and/or the computing system 500. Furthermore, the computing system 600 can perform one or more actions and/or operations that can be performed by the computing device 102, the server computing system 130, the training computing system 150, the computing device 300, and/or the computing system 500.

The computing system 600 can comprise the migration computing device 602, the task pool 604, the migration planner 606, the task 608, the migration controller 610, the review computing device 612, the code review queue 614, the code submit queue 616, and the task utilization component 618.

The migration computing device 602 can be configured to generate code migration data that can be sent to the review computing device 612. The task pool 604 can comprise code migration data which can comprise a plurality of migration tasks. The plurality of migration tasks from the task pool 604 can be sent to the migration planner 606. The migration planner 606 can be configured to determine a priority of each of the plurality of tasks from the task pool 604. The priority of the tasks from the task pool 604 can be used to determine an order in which each of the plurality of tasks from the task pool is sent to the migration controller 610. In this example, the task 608 (e.g., a migration task) can comprise information associated with a source and/or a destination of the task 608. In some embodiments, the task 608 can comprise an atomic migration instruction that can be used to migrate a code segment. The source of the task 608 can comprise a task from a codebase (e.g., a monolithic codebase) that is being migrated and/or a task from a community (e.g., a community comprising nodes corresponding to code segments that share dependencies and/or have dependency on one or more other code segments in the same community) the task 608 is associated with. For example, the task 608 can comprise a code segment (e.g., a code file) that is part of a community associated with a structured community assignment. The destination of the task 608 can comprise a target codebase to which the code segment in the task 608 can be migrated.

The task 608 can be sent to the migration controller 610 which can be configured to send tasks to the code review queue 614 of the review computing device 612. In some embodiments, the migration controller 610 can be configured to send parallel migration tasks (e.g., migration tasks that do not cause merge conflicts during migration and can be associated with other migration tasks in the same community). The migration controller 610 can send tasks comprising the task 608 to the code review queue 614 that is implemented in the review computing device 612. The code review queue 614 can comprise a plurality of tasks that can be reviewed and sent to the code submit queue 616 for submission to a destination codebase. The review computing device 612 can be configured to send tasks that exceed a predetermined code submit capacity to the task utilization component 618 of the migration computing device 602.

In some embodiments, the operations performed by the computing system 600 can be based on the Closed Loop Task Migration Code indicated in the following excerpt.

```
// Closed Loop Task Migration Code
procedure MigrationPlanner(taskPool):
  G := Dependency Graph of an Application
  M := DependencyGraph of running tasks ϵ taskPool
  for each task (source, destination) ϵ taskPool:
    if task is not blocked:
      continue
    subgraph := G.subgraph(source)
    if M .is_separate_component(subgraph):
      task.setState(ready)
      M .add(subgraph)
procedure MigrationController(taskPool, desired_utilization=1):
  ready_queue := Queue of ready tasks ϵ taskPool
  utilization := GetTaskUtilization(taskPool)
  while ready_queue not empty and utilization ≤ desired_utilization:
    task:=ready_queue.dequeue( )
    task.setState(running)
    migrate(task)
    utilization := GetTaskUtilization(taskPool)
procedure MigrationController(ready_queue):
  ready_tasks := number of ready tasks ϵ taskPool
  running_tasks := number of running tasks ϵ taskPool
  return running_tasks / (running_tasks + ready_tasks)
procedure TaskCompletedCallback(taskPool, event):
  task := taskPool[event.task_id]
  if event.task_completed_successfully:
    task.setState(terminated)
  else:
    task.setState(suspended)
```

In the preceding excerpt, code segments comprising instructions for closed loop migration using a migration planner and a migration controller are provided. The migration planner can be implemented as a procedure “MigrationPlanner (taskPool)” in which a task from a taskPool is a parameter. “G” indicates a dependency graph of an application (e.g., a map application) and “M” indicates an empty dependency graph. If a task is not blocked a task from the taskPool can be added to the empty graph in preparation for migration. The migration controller can be implemented as a procedure “MigrationController (ready_queue) in which the ready_queue from the MigrationPlanner procedure is a parameter. The migration controller can migrate tasks to the code review queue as long as the conditions that the ready_queue is not empty and the task utilization is less than a desired utilization (e.g., a task utilization threshold) are met. Further, the GetTaskUtilization procedure can be used to determine a task utilization based on running tasks and ready tasks. The task utilization can be based on a number of tasks that are being processed and/or are waiting to be submitted for inclusion in a destination codebase. Further, the TaskCompletedCallback procedure can be used to determine whether a migration task has been completed.

In the open loop migration indicated in the code segments, the MigrationController can terminate migration of migration tasks after a single control cycle. In the Closed Loop Task Migration Code, the task utilization can be maximized. The Task utilization feedback can be asynchronous listening for task completion events from Critique. When a task is complete, its respective subgraph can be removed from the controller and the migration planner can add a new migration task to the task queue (e.g., a code review queue), based on a build dependency graph indicating that the migration task can be classified as a separate component. If the queue is not empty, then task utilization can be determined to be less than a threshold level (e.g., full task utilization) and the migration controller can dynamically load-balance tasks by executing the task migration.

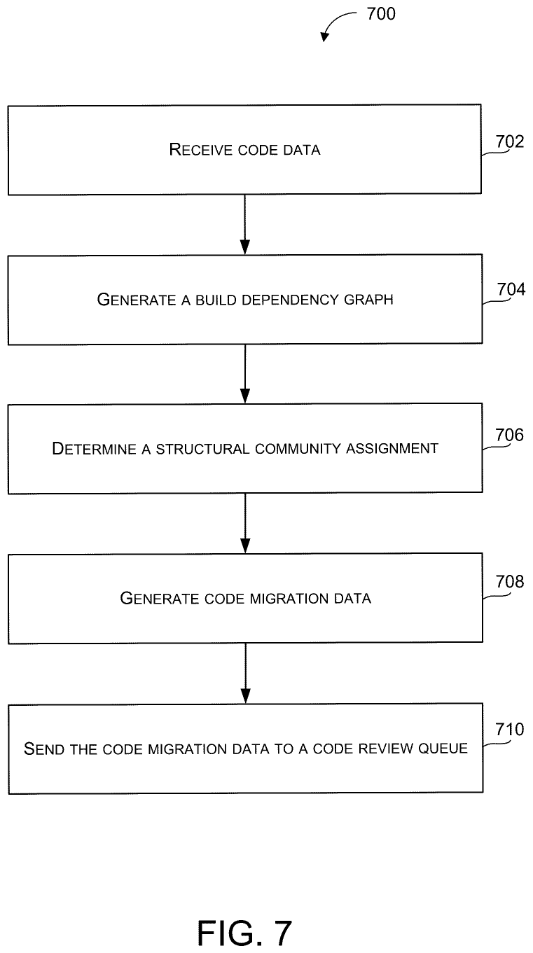

FIG. 7 depicts a flow chart diagram of an example method of generating structural community assignments for code migration according to example embodiments of the present disclosure. One or more portions of the method 700 can be executed and/or implemented on one or more computing devices or computing systems comprising, for example, the computing device 102, the server computing system 130, the training computing system 150, and/or the computing device 300. Further, one or more portions of the method 700 can be executed or implemented as an algorithm on the hardware devices or systems disclosed herein. FIG. 7 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 702, the method 700 can include receiving code data comprising a plurality of code segments. For example, the server computing system 130 can receive code data comprising a plurality of code segments (e.g., a plurality of source code files for a software application). The code data can be received from a local device and/or from a remote source (e.g., a remote computing system) via a network such as the network 180.

At 704, the method 700 can include generating a build dependency graph comprising a plurality of nodes and/or a plurality of edges. The plurality of nodes can correspond to the plurality of code segments. Further, the plurality of edges can correspond to a plurality of dependencies between the plurality of code segments. For example, the server computing system 130 can access the code data, process the plurality of code segments of the code data, determine dependencies between the plurality of code segments, and generate a build dependency graph in which the nodes of the build dependency graph correspond to code segments and the edges of the build dependency graph correspond to the plurality of dependencies between the plurality of code segments. Further, the server computing system 130 can generate build dependency graph data based on the build dependency graph.

At 706, the method 700 can include determining, over a plurality of iterations in which different combinations of the plurality of nodes are assigned to a plurality of communities, based on maximizing a modularity score associated with a modularity of the plurality of communities, a structural community assignment comprising an assignment of the plurality of nodes to the plurality of communities that maximizes the modularity score. The modularity score can be based on a density of the plurality of edges within each of the plurality of communities relative to the density of the plurality of edges outside each of the plurality of communities.

For example, the server computing system 130 can determine the structural community assignment by initially assigning the plurality of nodes to a random plurality of communities and changing the plurality of nodes in the plurality of communities after each iteration until either some threshold modularity score is achieved and/or some number of iterations of assigning the plurality of nodes to a plurality of communities has been performed. In some embodiments, the server computing system 130 can implement one or more machine-learned models that are configured and/or trained to determine and/or generate the structural community assignment based on input comprising the code data and/or the build dependency graph (e.g., build dependency graph data based on the build dependency graph).

At 708, the method 700 can include generating code migration data based on the structural community assignment. The code migration data can comprise a plurality of migration tasks associated with migrating the plurality of code segments based on the structural community assignment. For example, the server computing system 130 can process the structural community assignment and determine the plurality of code segments associated with each of the plurality of communities. The server computing system 130 can then perform operations to generate code migration data comprising a plurality of tasks in which each of the plurality of tasks comprises a code segment and a destination in a target codebase to which the code segment is being migrated.

At 710, the method 700 can include sending the code migration data to a code review queue. For example, the server computing system 130 can send, via a network such as the network 180, the code migration data to a code review queue that is implemented on another computing device. In some embodiments, the code migration data can be stored in the code review queue. In some embodiments, the code migration data can be in the code review queue for a predetermined period of time.

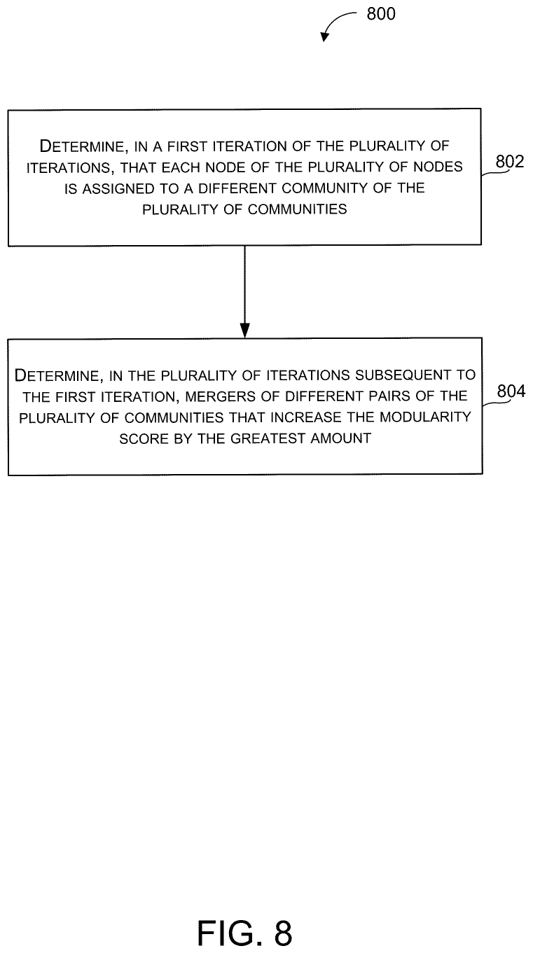

FIG. 8 depicts a flow chart diagram of an example method of generating structural community assignments for code migration according to example embodiments of the present disclosure. One or more portions of the method 800 can be executed and/or implemented on one or more computing devices or computing systems comprising, for example, the computing device 102, the server computing system 130, the training computing system 150, and/or the computing device 300. Further, one or more portions of the method 800 can be executed or implemented as an algorithm on the hardware devices or systems disclosed herein. In some embodiments, one or more portions of the method 800 can be performed as part of the method 700 that is described with respect to FIG. 7. FIG. 8 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 802, the method 800 can include determining, in a first iteration of the plurality of iterations, that each node of the plurality of nodes is assigned to a different community of the plurality of communities. For example, the server computing system 130 can receive code data comprising two thousand (2,000) code segments from which two thousand (2,000) nodes of a build dependency graph are generated. In the first iteration of determining the structural community assignment, the server computing system can assign each of the two thousand (2,000) nodes to two thousand (2,000) different communities such that each of the communities has one node assigned to it.

At 804, the method 800 can include determining, over the plurality of iterations subsequent to the first iteration, mergers of different pairs of the plurality of communities that increase the modularity score by a greatest amount. For example, the server computing system 130 can, over the second iteration and other iterations subsequent to the first iteration, perform operations in which pairs (two communities) are merged into a single community and a modularity score is determined. Different combinations of merged communities can result in different modularity scores and the combination of merged communities that maximize the modularity score can be used as the structural community assignment.

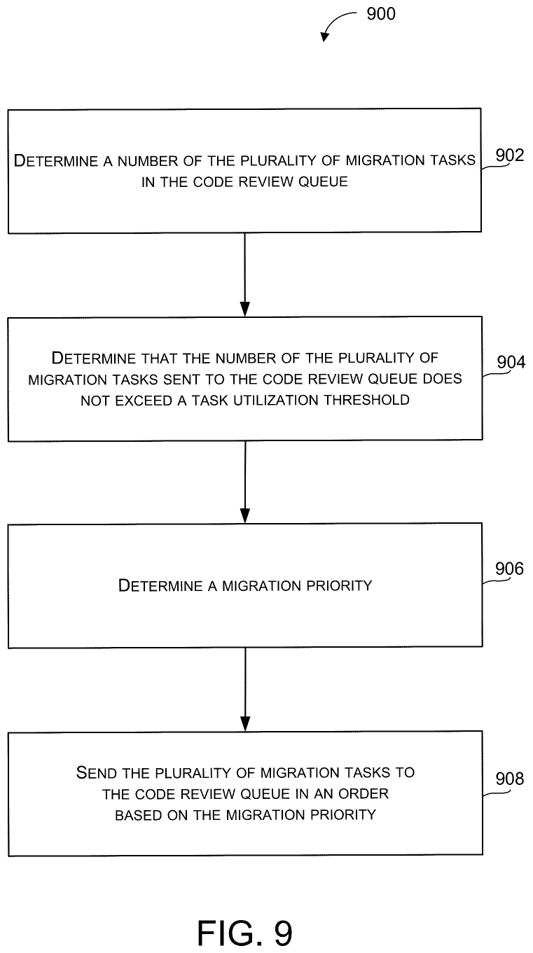

FIG. 9 depicts a flow chart diagram of an example method of generating structural community assignments for code migration according to example embodiments of the present disclosure. One or more portions of the method 900 can be executed and/or implemented on one or more computing devices or computing systems comprising, for example, the computing device 102, the server computing system 130, the training computing system 150, and/or the computing device 300. Further, one or more portions of the method 900 can be executed or implemented as an algorithm on the hardware devices or systems disclosed herein. In some embodiments, one or more portions of the method 900 can be performed as part of the method 700 that is described with respect to FIG. 7. FIG. 9 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 902, the method 900 can include determining a number of the plurality of migration tasks in the code review queue. For example, the server computing system 130 can access the code review queue and determine the number of the plurality of migration tasks in the code review queue.

At 904, the method 900 can include determining that the number of the plurality of migration tasks sent to the code review queue does not exceed a task utilization threshold associated with a capacity of the code review queue. For example, the server computing system 130 can keep track of task utilization (e.g., the number of the plurality of tasks in the code review queue) by monitoring the code review queue (e.g., continually or periodically monitoring the code review queue). Further, the server computing system 130 can send migration tasks to the code review queue when the task utilization is below the task utilization threshold.

At 906, the method 900 can include determining, based on a distance between the plurality of nodes, a migration priority associated with an order in which the plurality of migration tasks are sent to the code review queue. The migration priority of the plurality of migration tasks can be positively correlated with the distance between a pair of the plurality of code segments associated with the plurality of migration tasks. For example, if the build dependency graph comprises ten thousand (10,000) nodes corresponding to ten thousand (10,000) code segments, the server computing system 130 can determine distances between the plurality of nodes and determine a migration priority for the plurality of code segments corresponding to the plurality of nodes based on the distances between the plurality of nodes.

At 908, the method 900 can include sending the plurality of migration tasks to the code review queue in an order based on the migration priority. For example, if a migration priority for three tasks comprises task A with the highest priority, task B with secondary priority, and task C with the lowest priority, the server computing system 130 can send task A to the code review queue first, send task B to the code review queue after sending task A, and send task C to the code review queue after sending task A and task B.

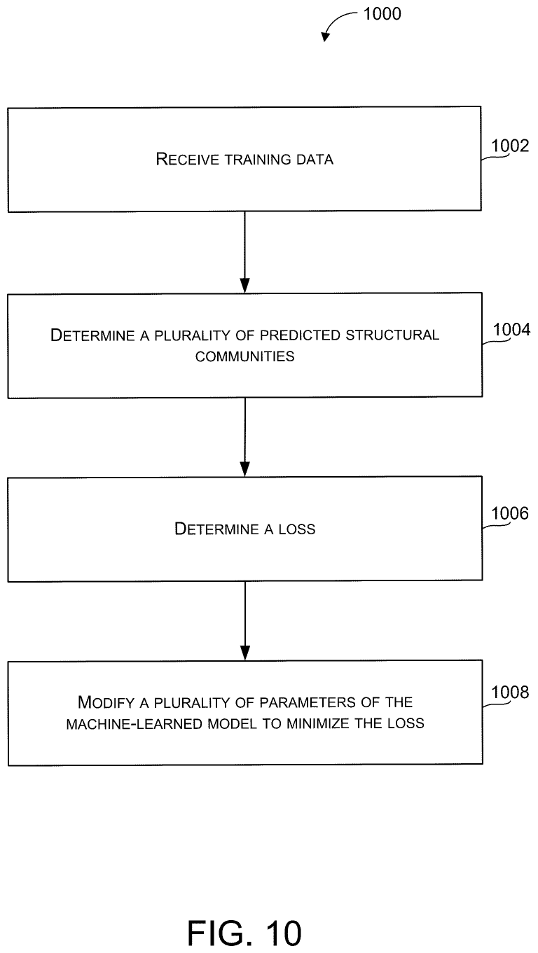

FIG. 10 depicts a flow chart diagram of an example method of training machine-learned models to generate structural community assignments for code migration according to example embodiments of the present disclosure. One or more portions of the method 1000 can be executed and/or implemented on one or more computing devices or computing systems comprising, for example, the computing device 102, the server computing system 130, the training computing system 150, and/or the computing device 300. Further, one or more portions of the method 1000 can be executed or implemented as an algorithm on the hardware devices or systems disclosed herein. In some embodiments, one or more portions of the method 1000 can be performed as part of the method 700 that is described with respect to FIG. 7. FIG. 10 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1002, the method 1000 can include receiving training data comprising a plurality of training build dependency graphs. The plurality of training build dependency graphs can comprise a plurality of training nodes connected by a plurality of training edges. Further, the plurality of training build dependency graphs can be associated with a corresponding plurality of ground-truth structural community assignments. Further, the plurality of training nodes can be associated with a plurality of training code segments. Further, the plurality of training edges can indicate dependencies between the plurality of training code segments. For example, the server computing system 130 can receive training data comprising a plurality of build dependency graphs for various applications that are being developed.

At 1004, the method 1000 can include determining, based on inputting the plurality of training build dependency graphs into one or more machine-learned models, a plurality of predicted structural community assignments. For example, the server computing system 130 can implement one or more machine-learned models. Further, based on inputting the plurality of training data inputs into the one or more machine-learned models, the one or more machine-learned models can perform one or more operations (e.g., assignment, merger, and/or redistribution operations) on the plurality of training build dependency graphs and generate an output comprising a plurality of predicted structural community assignments.

At 1006, the method 1000 can include determining a loss based on one or more differences between the plurality of predicted structural community assignments and the plurality of ground-truth structural community assignments. For example, over a plurality of iterations, the server computing system 130 can determine a loss (e.g., a cross-entropy loss) based on one or more differences between the plurality of predicted structural community assignments and the plurality of ground-truth structural community assignments. The one or more differences between the plurality of predicted structural community assignments and the plurality of ground-truth structural community assignments can be based on one or more comparisons of the plurality of predicted structural community assignments to the plurality of ground-truth structural community assignments.

At 1008, the method 1000 can include modifying a plurality of parameters of the one or more machine-learned models to minimize the loss. For example, the server computing system 130 can modify a plurality of weights of the plurality of parameters so that the weights of the plurality of parameters that contribute to reducing the loss (e.g., the parameters that increase the accuracy of the one or more machine-learned models generating a plurality of predicted structural community assignments that are accurate) are increased and/or the weights of the plurality of parameters that contribute to increasing the loss (e.g., the parameters that decrease the accuracy of the one or more machine-learned models generating a plurality of predicted structural community assignments that are accurate) are decreased. The plurality of weights of the plurality of parameters can be modified until some threshold loss (e.g., a minimized loss) that corresponds to a high accuracy of the plurality of predicted structural community assignments is achieved.

Further to the descriptions above, a user may be provided with controls allowing the user to make an election as to both if and/or when systems, programs, or features described herein may enable collection of user information (e.g., image information), and if the user is sent data or communications from a server. In addition, certain data may be treated in one or more ways before it is stored or used, so that certain information of a user may be removed. For example, a user's identity may be treated so that certain other information associated with the user's identity may not be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The technology discussed herein makes reference to servers, databases, software applications, and other computer-based systems, as well as actions taken and information sent to and from such systems. The inherent flexibility of computer-based systems allows for a wide variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A computer-implemented method of generating structural community assignments for code migration, the computer-implemented method comprising:
receiving, by a computing system comprising one or more processors, code data comprising a plurality of code segments;
generating, by the computing system, based on the code data, a build dependency graph comprising a plurality of nodes and a plurality of edges, wherein the plurality of nodes correspond to the plurality of code segments, and wherein the plurality of edges correspond to a plurality of dependencies between the plurality of code segments;
determining, by the computing system, over a plurality of iterations in which different combinations of the plurality of nodes are assigned to a plurality of communities, based on maximizing a modularity score associated with a modularity of the plurality of communities, a structural community assignment comprising an assignment of the plurality of nodes to the plurality of communities that maximizes the modularity score, wherein the modularity score is based on a density of the plurality of edges within each of the plurality of communities relative to the density of the plurality of edges outside each of the plurality of communities;
generating, by the computing system, code migration data based on the structural community assignment, wherein the code migration data comprises a plurality of migration tasks associated with migrating the plurality of code segments based on the structural community assignment; and
sending, by the computing system, the code migration data to a code review queue.

2. The computer-implemented method of claim 1, wherein the determining, by the computing system, over a plurality of iterations in which different combinations of the plurality of nodes are assigned to a plurality of communities, based on maximizing a modularity score associated with a modularity of the plurality of communities, a structural community assignment comprising an assignment of the plurality of nodes to the plurality of communities that maximizes the modularity score comprises:
determining, by the computing system, in a first iteration of the plurality of iterations, that each node of the plurality of nodes is assigned to a different community of the plurality of communities; and
determining, by the computing system, over the plurality of iterations subsequent to the first iteration, mergers of different pairs of the plurality of communities that increase the modularity score by a greatest amount.

3. The computer-implemented method of claim 1, wherein the modularity score is positively correlated with a difference between an assignment of the plurality of nodes to the plurality of communities and a random assignment of the plurality of nodes to the plurality of communities.

4. The computer-implemented method of claim 1, wherein the modularity score is positively correlated with the density of the plurality of edges within the plurality of communities relative to the density of the plurality of edges outside the plurality of communities.

5. The computer-implemented method of claim 1, wherein the modularity score is negatively correlated with a distance between the plurality of nodes in the plurality of communities, and wherein the distance between the plurality of nodes is based on a number of intervening nodes between a pair of nodes of the plurality of nodes.

6. The computer-implemented method of claim 1, wherein a first iteration of the plurality of iterations is based on a random assignment of the plurality of nodes to the plurality of communities.

7. The computer-implemented method of claim 1, wherein the plurality of nodes assigned to each of the plurality of communities is mutually exclusive with respect to the plurality of nodes assigned to other communities of the plurality of communities.

8. The computer-implemented method of claim 1, wherein the determining the structural community assignment is performed by one or more machine-learned models trained to determine the structural community assignment based on input comprising the code data and the build dependency graph.

9. The computer-implemented method of claim 8, wherein the one or more machine-learned models comprise one or more auto-encoder models.

10. The computer-implemented method of claim 8, wherein the training of the one or more machine-learned models comprises:
receiving, by the computing system, training data comprising a plurality of training build dependency graphs comprising a plurality of training nodes connected by a plurality of training edges, wherein the plurality of training build dependency graphs are associated with a corresponding plurality of ground-truth structural community assignments, wherein the plurality of training nodes are associated with a plurality of training code segments, and wherein the plurality of training edges indicate dependencies between the plurality of training code segments;
determining, by the computing system, based on inputting the plurality of training build dependency graphs into the one or more machine-learned models, a plurality of predicted structural community assignments;
determining, by the computing system, a loss based on one or more differences between the plurality of predicted structural community assignments and the corresponding plurality of ground-truth structural community assignments; and
modifying, by the computing system, a plurality of parameters of the one or more machine-learned models to minimize the loss.

11. The computer-implemented method of claim 1, wherein the plurality of code segments are associated with a plurality of directories, and wherein the plurality of code segments associated with a same directory of the plurality of directories correspond to the plurality of nodes assigned to a same community of the plurality of communities.

12. The computer-implemented method of claim 1, wherein a number of the plurality of iterations is based on a predetermined threshold number of iterations.

13. The computer-implemented method of claim 1, wherein the plurality of iterations continues until the modularity score exceeds a modularity score threshold.

14. The computer-implemented method of claim 1, wherein the sending, by the computing system, code migration data to a code review queue comprises:
determining, by the computing system, a number of the plurality of migration tasks in the code review queue; and
determining, by the computing system, that the number of the plurality of migration tasks sent to the code review queue does not exceed a task utilization threshold associated with a capacity of the code review queue.

15. The computer-implemented method of claim 1, wherein the sending, by the computing system, code migration data to a code review queue comprises:
determining, by the computing system, based on a distance between the plurality of nodes, a migration priority associated with an order in which the plurality of migration tasks are sent to the code review queue, wherein the migration priority of the plurality of migration tasks is positively correlated with the distance between a pair of the plurality of code segments associated with the plurality of migration tasks; and
sending, by the computing system, the plurality of migration tasks to the code review queue in an order based on the migration priority.

16. One or more tangible non-transitory computer-readable media storing computer-readable instructions that when executed by one or more processors cause the one or more processors to perform operations, the operations comprising:
receiving code data comprising a plurality of code segments;
generating a build dependency graph comprising a plurality of nodes and a plurality of edges, wherein the plurality of nodes correspond to the plurality of code segments, and wherein the plurality of edges correspond to a plurality of dependencies between the plurality of code segments;
determining, over a plurality of iterations in which different combinations of the plurality of nodes are assigned to a plurality of communities, based on maximizing a modularity score associated with a modularity of the plurality of communities, a structural community assignment comprising an assignment of the plurality of nodes to the plurality of communities that maximizes the modularity score, wherein the modularity score is based on a density of the plurality of edges within each of the plurality of communities relative to the density of the plurality of edges outside each of the plurality of communities;
generating code migration data based on the structural community assignment, wherein the code migration data comprises a plurality of migration tasks associated with migrating the plurality of code segments based on the structural community assignment; and
sending the code migration data to a code review queue.

17. The one or more tangible non-transitory computer-readable media of claim 16,
wherein the modularity score is positively correlated with a difference between an assignment of the plurality of nodes to the plurality of communities and a random assignment of the plurality of nodes to the plurality of communities.

18. A computing system comprising:
one or more processors;
one or more non-transitory computer-readable media storing instructions that when executed by the one or more processors cause the one or more processors to perform operations comprising:
receiving code data comprising a plurality of code segments;
generating a build dependency graph comprising a plurality of nodes and a plurality of edges, wherein the plurality of nodes correspond to the plurality of code segments, and wherein the plurality of edges correspond to a plurality of dependencies between the plurality of code segments;
determining, over a plurality of iterations in which different combinations of the plurality of nodes are assigned to a plurality of communities, based on maximizing a modularity score associated with a modularity of the plurality of communities, a structural community assignment comprising an assignment of the plurality of nodes to the plurality of communities that maximizes the modularity score, wherein the modularity score is based on a density of the plurality of edges within each of the plurality of communities relative to the density of the plurality of edges outside each of the plurality of communities;
generating code migration data based on the structural community assignment, wherein the code migration data comprises a plurality of migration tasks associated with migrating the plurality of code segments based on the structural community assignment; and
sending the code migration data to a code review queue.

19. The computing system of claim 18, wherein the modularity score is positively correlated with the density of the plurality of edges within the plurality of communities relative to the density of the plurality of edges outside the plurality of communities.

20. The computing system of claim 18, wherein the modularity score is positively correlated with a difference between an assignment of the plurality of nodes to the plurality of communities and a random assignment of the plurality of nodes to the plurality of communities.
